(19) United States
(12) Patent Application Publication
(10) Pub. No.: US 2018/0117611 A1
(43) Pub. Date: May 3, 2018

(54) LOW-PRESSURE AND LOW-NOISE SPRAY DEVICE

(71) Applicant: San-Ching Chen, New Taipei City (TW)

(72) Inventor: San-Ching Chen, New Taipei City (TW)

(21) Appl. No.: 15/854,795

(22) Filed: Dec. 27, 2017

Related U.S. Application Data
(63) Continuation-in-part of application No. 14/578,655, filed on Dec. 22, 2014.

(51) Int. Cl. B05B 7/24; B05B 7/00

(52) U.S. Cl. CPC B05B 7/2416; B05B 7/0081; F04B 45/04; B05B 15/065; B05B 7/2424

(57) ABSTRACT

A spray device includes a diaphragm pump that is operated to generate an air flow of 200-250 L/min at a low pressure of 2-3 psi. A spray gun receives the air flow from the diaphragm pump and includes a Venturi tube structure through which the air flow moves. A paint receptacle that receives and holds therein a paint material is connected to the spray gun to allow the paint material to get into the Venturi tube structure to be converted into paint droplets entraining the air flow. A hose has a diameter of 1.5 cm is connected between the diaphragm pump and the spray gun to conduct the air flow from the diaphragm pump to the spray gun so that the paint droplets can be sprayed out to a workpiece with the low pressure of 2-3 psi without causing significant rebounding from the workpiece.

### CROSS-REFERENCE TO RELAYED APPLICATION

This is a continuation-in-part of co-pending U.S. patent application Ser. No. 14/578,655 filed on Dec. 22, 2014 and owned by the present applicant.

### BACKGROUND OF THE INVENTION

### (a) Technical Field of the Invention

The present invention generally relates to a spray device, and more particularly to a spray device operated with a low pressure and generating a low level of noise in the operation thereof.

### (b) Description of the Prior Art

Spray devices, such as painting sprayers, operated with pressurized air supplied from an air compressor are known. The air compressor used with such a spray device is a piston-type air compressor that is operated at a power of 3 Hp (2,200 W), which generates a very high level of noise that is uncomfortable to the users. Such an air compressor supplies a pressurized airflow at a pressure level higher than 30-50 psi. It is common in paint spraying to use a hose having a diameter not greater than 0.6 cm to connect to air compressor and a paint sprayer. This provides an extremely high speed of paint jet, which when hitting a wall, rebound from the wall and spread into the surrounding air, causing undesired contamination and harm to human body for a user standing nearby. This also causes a loss of paint.

Apparently, improvements are necessary for such a known paint spraying system in order to reduce the power consumed and noise generated during the operation of the air compressor and also to reduce unnecessary contamination and harm to the surroundings, as well as undesired loss of paint.

### SUMMARY OF THE INVENTION

Thus, an objective of the present invention is to provide a low-pressure and low-noise spray device that overcomes the above-discussed drawbacks of the prior art.

To achieve the above objective, the present invention provides a spray device, which comprises:

a diaphragm pump that is operated at noise level of 55 dB with a power consumption of 250 W to generate air flow of 200-250 L/min at an air pressure of 2-3 psi, the diaphragm pump comprising an air outlet to supply the air flow;

a spray gun that comprises a Venturi tube structure and has an air inlet to receive the air flow supplied from the diaphragm pump and guide the air flow into the Venturi tube structure, the spray gun comprising a paint receptacle that receives and holds therein a paint material that is supplied into the spray gun and atomize to form paint droplets entraining the air flow received from the diaphragm pump to allow the paint droplets to be sprayed onto a workpiece; and

a hose having two ends respectively coupled, in releasable manner, to the air outlet of the diaphragm pump and the air inlet of the spray gun for conducting the air flow from the diaphragm pump to the spray gun, the hose having a diameter of 1.5 cm to supply the flow rate of 200-250 L/min at the air pressure of 2-3 psi from the diaphragm pump to the spray gun, such that the paint droplets sprayed out of the spray gun onto the workpiece rebound from the workpiece by a distance not greater than 5 cm.

In an embodiment of the present invention, the diaphragm pump comprises a power switch for turning on/off the diaphragm pump.

In an embodiment of the present invention, the diaphragm pump comprises a handle for hand gripping and carrying.

In an embodiment of the present invention, the coupling between the ends of the hose and the air inlet of the spray gun is achieved with screwing or a quick connector.

In an embodiment of the present invention, the coupling between the ends of the hose and the air outlet of the diaphragm pump is achieved with screwing or a quick connector.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing a spray device according to the present invention.

FIG. 2 is an exploded view of the spray device of the present invention.

FIG. 3 is a schematic view illustrating a Venturi tube used in the present invention for creating a low-pressure airflow with which paint droplets entrain.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

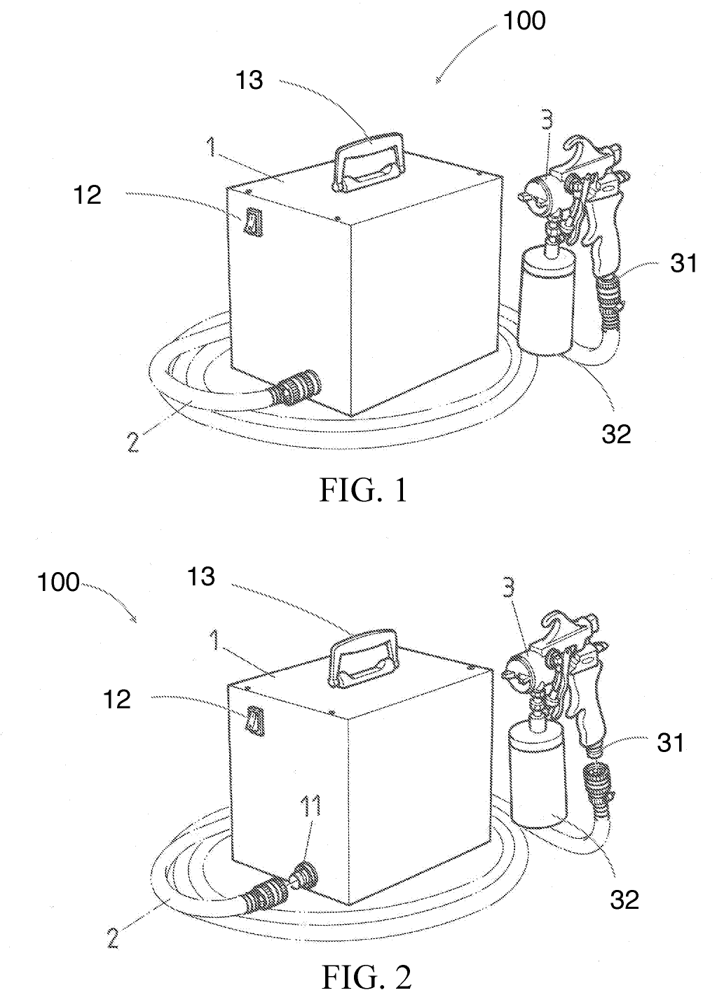

Referring to FIGS. 1 and 2, the present invention provides a low-pressure and low-noise spray device, generally designated at 100, which comprises an air pump 1, which is preferably a low-voltage electromagnetic diaphragm pump, having an air outlet 11. A power switch 12 is provided on the air pump 1 to selectively turn on/off the pump 1. Preferably, a handle 13 is also provided and mounted to the pump 1 for hand gripping and carrying.

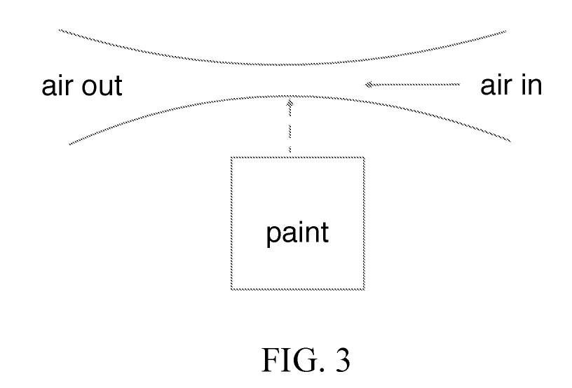

The spray device 100 also comprises a spray gun 3, which comprises an air inlet 31 that receives a supply of air from the pump 1. A paint receptacle 32 receives and holds therein a paint material and is connected to the spray gun 3 to supply paint to the spray gun 3. The paint receptacle 32 is removable from the spray gun 3 for replacement or replenishment of the paint material. Preferably, the spray gun 3 comprises, in an interior thereof, a Venturi tube based structure, as shown in FIG. 3, that includes a length of tube having varying diameter and including an inlet, which is marked as “air in” in FIG. 3, to receive the airflow supplied from the pump 1. The Venturi tube has a narrowest section between the inlet and an opposite outlet (marked “air out” in FIG. 3) and connected with the paint receptacle in order to allow paint to be supplied from the paint receptacle into the airflow passing through the Venturi tube so as to allow paint droplets to entrain the airflow and sprayed out through the outlet of the Venturi tube.

A hose or tube 2 is provided to connect the pump 1 to the spray gun 3. The hose 2 has two ends respectively connected to the air outlet 11 of the pump 1 and the air inlet 31 of the spray gun 3. Preferably, the connection between the hose 2 and the air outlet 11 of the pump 1 and the air inlet 31 of the spray gun 3 is achieved with screwing or quick connectors. It is particularly noted here that in order to maintain a low pressure of the air supplied through the hose 2 and the spray gun 3 and also to prevent undesired loss of pressure, the hose 2 is configured with a diameter that is not less than 1.5 cm. Compared to the 0.6 cm diameter tube used in the known spray system, the 1.5 cm diameter tube allows for a sufficiently large airflow of a low pressure to be supplied from the air pump 1 to the spray gun 3.

The air pump 1 is preferably a low wattage pump operated with a low AC power or a portable DC battery. An example of the air pump 1 is a low-pressure electromagnetic diaphragm pump, which generates a large volume of air flow but at a much lower level of noise compared to the conventionally used air compressor. The diaphragm pump of this invention may generate an air flow of 200-250 L/min and this flow rate is large enough for such a low pressure to atomize paint in the spray gun 3. The noise generated with the air pump 1 of this invention, which is a diaphragm pump, is not more than 55 dB(A), while the conventional air compressor generally has a noise over 100 dB(A). Power consumption of the conventional air compressor, which is generally operated with a reciprocal movement of a piston, is around 2,200 W, while that of the diaphragm pump used in this invention is around 250 W This is a huge difference.

A lot of air is pumped through the hose 2, which has a large diameter, as large as 1.5 cm, at a low pressure to the spray gun, which is also operated at such a low pressure, rather than the 30-50 psi high pressure sprayers that are conventionally used, so that the airflow induced through the spray gun 3 effectively atomizes paint by drawing paint droplets into the airflow for eventually coating on a wall. The large volume of air supplied from the diaphragm pump 1 allows the paint to entrain the airflow in a large amount for painting in a quick and efficient way. The low pressure of air used in the present invention, which is no more than about 2-3 psi, may effectively carry the paint droplets onto the wall in a moderate manner and thus, rebounding of paint droplets from the wall due to excessively impacting force of the paint droplets against the wall can be eliminated. The paint can be completely attached to the wall or any article to which the paint is sprayed. This helps reduce the loss of paint. The present invention can reduce the consumption and waste of power and noise pollution, and can reduce loss of paint or coating.

Hoses having a diameter of 1.5 cm often have a relatively thin tubular wall. This makes it is not possible for the 1.5 cm diameter hose to bear a pressure as high as 30-50 psi generated in the conventionally used air compressor. Although thickening tubular wall of the tube can be made for bearing a high pressure, such a thickened tubular wall makes the tube stiff. Stiff tube or hose is undesired for it interferes with a user's operation and moving of the spray gun 3 around a working site. Considering this, it is proposed in this invention that a hose or tube having a diameter of 1.5 cm but not with an increased tubular wall be used for working with a low air pressure of 2-3 psi generated and supplied with a diaphragm pump to allow for a supply of sufficient amount of paint and prevent paint droplets from rebounding from the wall surface due to excessively impacting force. It is noted that the paint droplets, when sprayed with an air pressure of 30 psi, rebound at a large amount for a distance of around 50 cm, while for this invention, the 2-3 psi low pressure causes only a minor amount of paint droplets rebounding from the wall for a much shorter distance of around 5 cm.

In addition, such a large diameter of 1.5 cm as adopted for the hose 2 is also advantageous in preventing excessive pressure drop due to friction with the inside surface of the hose 2. A small diameter hose, such as those used conventionally, which is 0.6 cm, would create a large frictional force on the inside surface of the hose. And, this would result in an addition loss of air pressure, and also energy.

As noted above, although the conventional air compressor, which is generally based on reciprocal movement of a piston, may provide an air pressure of 2 or 3 psi by including a regulator, the operation of such a conventional air compressor is noisy; and in addition, such a low pressure is not applicable to the conventional spray gun that is commonly used with an air compressor for such a conventional spray gun is operated with a high pressure and does not atomize paint liquid if the air pressure supplied thereto is not high enough.

The piston type air compressor, although supplying a high pressure, may not provide a sufficient large volume of airflow for atomization of paint in working with the spray gun of this invention. The piston type air compressor may be expanded in size to increase the output amount of airflow, yet this increases the operation noise, making it not a reasonable solution.

To operate a spray gun with a low pressure of 2-3 psi in a relatively silent condition, the conventionally used air compressor that generates a high level of noise and the conventionally used atomizer spray gun that is operated at a high pressure of at least 30 psi must replaced with the air pump and spray gun of this invention.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A spray device, comprising:
a diaphragm pump that is operated at noise level of 55 dB with a power consumption of 250 W to generate air flow of 200-250 L/min at an air pressure of 2-3 psi, the diaphragm pump comprising an air outlet to supply the air flow;
a spray gun that comprises a Venturi tube structure and has an air inlet to receive the air flow supplied from the diaphragm pump and guide the air flow into the Venturi tube structure, the spray gun comprising a paint receptacle that receives and holds therein a paint material that is supplied into the spray gun and atomize to form paint droplets entraining the air flow received from the diaphragm pump to allow the paint droplets to be sprayed onto a workpiece; and
a hose having two ends respectively coupled, in releasable manner, to the air outlet of the diaphragm pump and the air inlet of the spray gun for conducting the air flow from the diaphragm pump to the spray gun, the hose having a diameter of 1.5 cm to supply the flow rate of 200-250 L/min at the air pressure of 2-3 psi from the diaphragm pump to the spray gun, such that the paint droplets sprayed out of the spray gun onto the workpiece rebound from the workpiece by a distance not greater than 5 cm.

2. The spray device according to claim 1, wherein the diaphragm pump comprises a power switch for turning on/off the diaphragm pump.

3. The spray device according to claim 1, wherein the diaphragm pump comprises a handle for hand gripping and carrying.

4. The spray device according to claim 1, wherein the coupling between the ends of the hose and the air inlet of the spray gun is achieved with screwing or a quick connector.

5. The spray device according to claim 1, wherein the coupling between the ends of the hose and the air outlet of the diaphragm pump is achieved with screwing or a quick connector.
